(19) United States
(12) Patent Application Publication
(10) Pub. No.: US 2010/0288854 A1
(43) Pub. Date: Nov. 18, 2010

(54) Watering wand and plant-feeding system

(76) Inventors: Wilson A. Felknor, Lenoir City, TN (US); Britton A. Felknor, Clinton, TN (US)

Correspondence Address: Michael E. McKee;Attorney at Law, 804 Swaps Lane, Knoxville, TN, 37923, US

(21) Appl. No.: 12/799,785

(22) Filed: Apr. 30, 2010

Related U.S. Application Data
(60) Provisional application No. 61/215,063, filed on May 1, 2009.

(51) Int. Cl. B05B 15/06

(52) U.S. Cl. 239/532

(57) ABSTRACT

A watering wand system for delivering water to an elevated planter utilizes a stiff hollow tube having a crooked head end which accommodates the hooking of the head end over the upper edge of a planter, a grip of substantial thickness, and a spacer member joined to the tube adjacent the head end thereof which separates the head end of the tube from the dirt or potting soil contained within the planter when the head end is hooked over the upper edge of the planter. A conduit is connected to the tube for delivery of water to the tube from a source, a nutrient-containing assembly is connected in-line with the conduit, and a valve assembly is associated with the conduit for permitting a user to set the rate of water flowing through the tube at relatively slow conditions.

The benefit of Provisional Application Ser. No. 61/215,063, filed May 1, 2009 and entitled WATERING WAND SYSTEM is hereby claimed. The disclosure of this referenced provisional patent application is incorporated herein by reference.

### BACKGROUND OF THE INVENTION

This invention relates generally to gardening accessories and relates, more particularly, to means and methods with which planters are watered.

The class of gardening accessories with which this invention is to be compared includes conduit systems which are connectable to a source of water for directing water which is conducted from the source to a desired location, such as into a planter within which plants are grown.

It would be desirable to provide a conduit system of the aforedescribed class which includes a watering wand which is particularly well-suited for delivering water to a planter which is disposed in an elevated position with respect to (e.g. above the head of) a gardener who desires to deliver water to the planter.

Accordingly, it is an object of the present invention to provide a new and improved watering wand system which can be used to conduct water to an elevated planter which would be difficult to water with a hand-held watering can or similar conventional watering means.

Another object of the present invention is to provide such a system which employs a watering wand which can be hooked about the edge of an elevated planter for ease of watering the planter.

Still another object of the present invention is to provide such a system whose watering wand has a head which is maintained at a desired spacing above the upper surface of dirt or soil contained within the planter to be watered with the system.

Yet another object of the present invention is to provide such a system whose watering wand is relatively easy to grasp for use.

A further object of the present invention is to provide such a system having a nutrient-holding assembly within which fertilizer, such as solid granular fertilizer, can be introduced into the flow of water routed to the watering wand.

A still further object of the present invention is to provide such a system whose components are relatively light in weight, even when filled with water.

One more object of the present invention is to provide such a system which is relatively uncomplicated in structure, yet effective in operation.

### SUMMARY OF THE INVENTION

This invention resides in a watering wand system for delivering water to an elevated planter having an upper edge.

The watering wand system includes a relatively stiff hollow tube having a head end and an opposite handle end and defines a water flow passageway which extends between the head and handle ends of the tube. The tube includes a crooked portion adjacent the head end of the tube which permits the head end of the tube to be hooked over the upper edge of an elevated planter for purposes of delivering water from the head end of the tube into the planter. In addition, the system includes a nutrient-containing assembly having a hollow interior for holding plant nutrients placed therein and which is connected in-line with the water flow passageway of the hollow tube so that water which is routed toward the hollow tube from a source enters the nutrient-containing assembly and is permitted to mix with nutrients placed therein before for delivery to a planter through the hollow tube.

### BRIEF DESCRIPTION OF THE DRAWINGS

FIG. 1 is a perspective view of an embodiment of a watering wand system within which features of the present invention are incorporated.

FIG. 2 is a view of the head end of the tube of the FIG. 1 system, as viewed from the end thereof.

FIG. 3 is a side elevational view of the nutrient-holding assembly of the FIG. 1 system, shown with the top removed therefrom.

FIG. 4 is a perspective view illustrating the FIG. 1 system being used to deliver water and nutrients to an elevated planter.

FIG. 5 is a cross-sectional view of a fragment of the planter depicted in FIG. 4 showing the crooked end of the tube hooked over an upper edge of the planter of FIG. 4.

FIG. 6 is a fragmentary perspective view of an alternative embodiment of a watering wand system within which features of the present invention are incorporated.

FIG. 7 is a view similar to that of FIG. 2 of the head end of a tube of an alternative embodiment of the system of the invention.

### DETAILED DESCRIPTION OF AN ILLUSTRATIVE EMBODIMENT

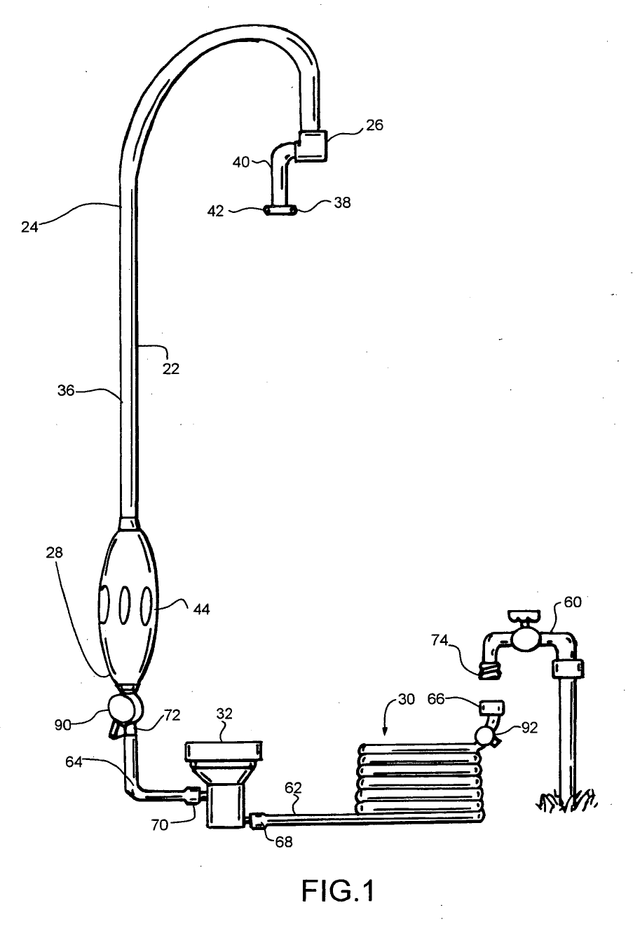

Turning now to the drawings in greater detail and considering first FIG. 1, there is illustrated an embodiment, generally indicated 20, of a watering wand and plant-feeding system within which features of the present invention are embodied. The system 20 includes a watering wand 22 constructed of an elongated hollow tube 24 having a head end 26, an opposite handle end 28 and an internal flow passageway which extends between the handle end 28 and the head end 26 of the tube 24. The system 20 also includes a conduit, or conduit means, generally indicated 30, for conducting water to the handle end 28 of the tube 24 and a nutrient-containing assembly 32 which is connected in-line with the conduit 30.

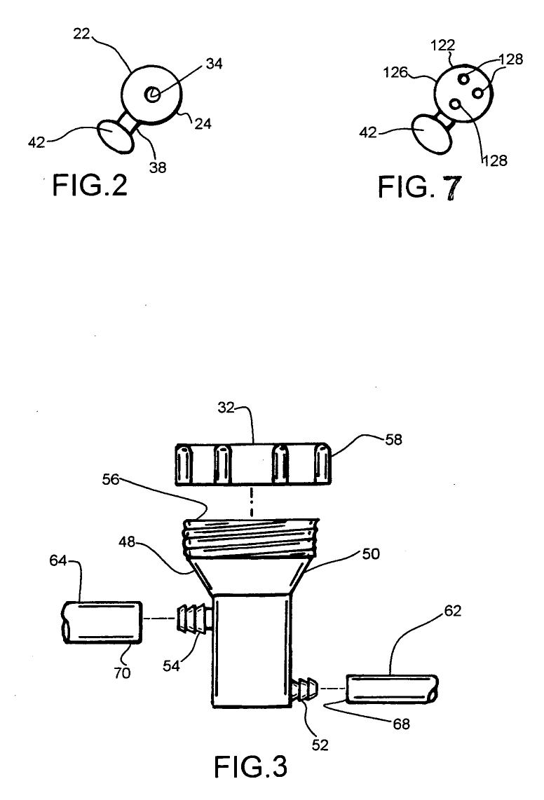

The tube 24 of the watering wand 22 is crooked (to form a U-shape) at the head end 26 of the tube 24, and the tube 24 further includes a lengthy portion 36 adjacent the handle end 28 of the tube 24 which is straight for a major segment of the length of the tube 24. For dispensing water from the tube 24, the head end 26 includes one discharge opening 34 (best shown in FIG. 2) which is in flow communication with the internal flow passageway of the tube 24. The U-shaped form of the tube 24 at the head end 26 of the tube 24 is advantageous in that it enables the head end 26 of the tube 24 to be hooked over the upper edge of a planter which is supported in an elevated condition.

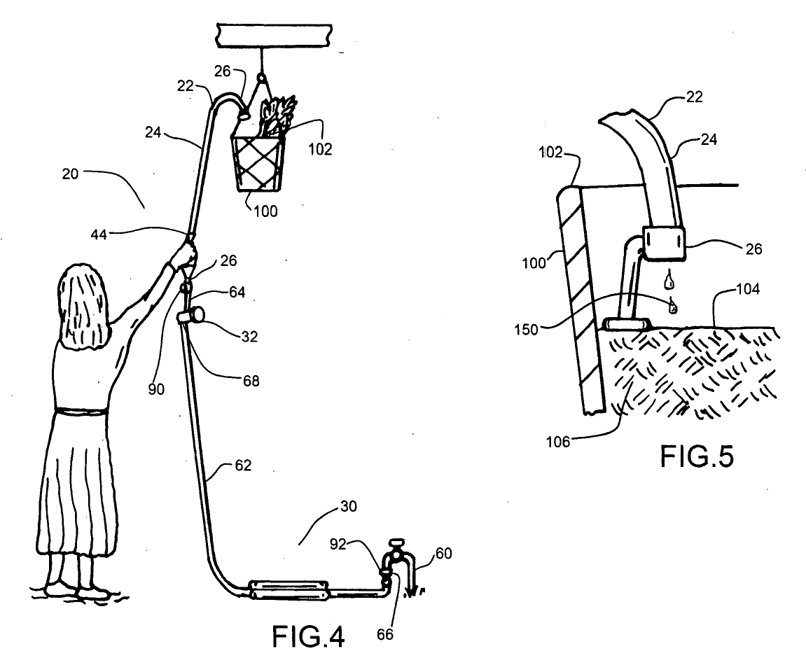

Furthermore, there is associated with the head end 26 of the tube 24 a spacer member 38 including a shank portion 40 (FIG. 1)—which is between about 1.5 inches and 2.0 inches in length, and preferably about 1.75 inches in length—which is joined to one side of the head end 26 and a foot portion 42 joined to the shank portion 40 at the free end thereof which is adapted to rest upon the upper surface of the dirt or potting soil contained within an elevated planter, such as the elevated planter 100 of FIG. 4. More specifically and during use of the watering wand 22, the head end 26 of the tube 24 is hooked over the upper edge of an elevated planter and the foot portion 42 rests atop the dirt or potting soil contained within the planter so that the spacer member 38 maintains a desired spaced distance (e.g. of about 1.5 inches) between the head end 26 of the tube 24 (from which water is discharged from the tube 24) and the upper surface of the dirt or potting soil contained within the planter. This spaced relationship is desirable to ensure that the head end 26 of the tube 24 does not inadvertently become buried within or become plugged by the dirt or potting soil contained within the planter.

The watering wand 22 also includes a bulbuous portion 44 disposed about the tube 24 adjacent the handle end 28 thereof. This bulbuous portion 44 provides a relatively thick grip for a user who holds the wand 22 and is believed to be relatively easy to grasp (because of its substantial thickness), even by an individual who may experience arthritis pain in the joints of his grasping hand. Each of the aforedescribed components of the watering wand 22 is constructed, or molded, out of a relatively hard plastic to provide the wand 22 with relatively stiff nature.

With reference to FIG. 3, the nutrient-containing assembly 32 includes a receptacle portion 50 which has a hollow interior and an inlet port 52 and an outlet port 54 which are in flow communication with the interior of the receptacle portion 50. The outlet port 54 is disposed at a higher elevation than and in an offset relationship with the inlet port 52 with respect to the receptacle portion 50 (as is best shown in FIGS. 1 and 2) to facilitate the mixing of the nutrients contained within the receptacle portion 50 with water routed therethrough before the water/nutrient mixture exits the receptacle portion 50 through the outlet port 54. In addition, the receptacle portion 50 has a mouth 56 through which fertilizer (liquid or solid) can be poured or deposited into the interior of the receptacle portion 50 and a removable top 58 which can be threadably attached to or detached from the receptacle portion 50 for opening or closing the mouth 56 thereof. Moreover, the receptacle portion 50 includes a section, indicated 48 in FIG. 3, surrounding the mouth 56 thereof which is somewhat funnel-shaped to facilitate the placement (by pouring or deposit) of the fertilizer into the interior of the receptacle portion 50.

With reference again to FIGS. 1 and 3, the conduit 30 includes a network of conduits (described herein) which are connectable between a water source (such as the discharge end of a water faucet 60 in FIG. 1 or the discharge end of a garden hose, not shown) and the handle end 28 of the tube 24 for conducting water from the source 60 to the flow passageway of the tube 24. Within the depicted system 20, the conduit 30 includes two tubular sections 62 and 64. One tubular section 62 has an inlet end 66 and an opposite outlet end 68, and the other tubular section 64 has an inlet end 70 and an opposite outlet end 72. The inlet end 66 of the tubular section 62 is adapted to be connected to the spout 74 of a faucet 60 (or the male connector of a garden hose) for accepting water from the faucet 60 or garden hose, and the outlet end 68 of the tubular section 62 is connected to (i.e. sealingly positioned about) the inlet port 52 of the receptacle portion 50. Preferably, the tubular section 62 possesses a relatively small diameter (e.g. having an outer diameter of about 0.25 inches) so that even when filled with water, the tubular section 62 is relatively light in weight.

Meanwhile, the inlet end 70 of the tubular section 64 is connected to (i.e. sealingly positioned about) the outlet port 54 of the receptacle portion 50, and the outlet end 72 is connected to (i.e. sealingly positioned about) to the handle end 28 of the tube 24 of the watering wand 22. Within the depicted system 20, the nutrient-containing assembly 32 is joined to the watering wand 22 so as to be in relatively close proximity thereto (e.g. within about four feet) so that a user who is using the wand 22 does not have to travel far from the wand 22 in order to fill (or re-fill) the nutrient-containing assembly 32. Accordingly and to this end, the tubular section 64 is relatively short in length (e.g. does not exceed about four feet).

One of the advantages provided by the system 20 relates to its capacity to accept solid (e.g. granular) fertilizer within its nutrient-containing assembly 32 for mixing with water flowing through the conduit 30 for eventual discharge out of the head end 26 of the tube 24. In this connection, the flow passageways associated with each of the receptacle portion 50 (and in particular, the outlet port 54 thereof), the tubular section 64 and the tube 24 are large enough in diameter to reduce the likelihood that undissolved grains of granular fertilizer will become clogged or lodged within any of these passageways.

It is another feature of the system 20 that it includes valve assemblies, described herein, associated with the conduit 30 which enable a user to adjust the flow rate of the water flowing through the tube 24 between ON and OFF conditions and enables the flow rate to be set at a relatively slow, or drip, flow rate conditions.

Within the system 20 and as best shown in FIG. 1, one such valve assembly, indicated 90, is mounted at the handle end 28 of the tube 24, and another such valve assembly 92 is mounted within the tubular section 62 of the conduit 34 adjacent the inlet end 66 thereof. Because either of these valves 90 or 92 can be used to set the flow rate of water passing therethrough at relatively slow, or drip-rate, flow conditions provides the user with the option of setting the flow rate of water discharged from the head end 26 of the tube 24 either at a location situated adjacent the handle end 28 of the tube 24 or at a location situated adjacent the source 60. Furthermore, by setting the valve assembly 90 or 92 at the slow, or drip, flow rate condition, the head end 26 of the tube 24 can be used for delivering water (and plant nutrients) to the planter for a relatively lengthy period of time.

With reference to FIGS. 4 and 5, there is depicted the watering wand system 20 being used to deliver water 150 to an elevated planter 100 which would be otherwise difficult to water by conventional means (e.g. a hand-held watering can). In this connection, the water wand 22 is grasped by the handle end 28 thereof, and the crooked end 26 of the tube 24 is hooked over the upper edge, indicated 102 in FIG. 5, of the planter 100. With the crooked head end 26 of the tube 24 appropriately hooked over the upper edge 102 of the planter 100, the foot portion 42 of the spacer member 36 rests upon the upper surface, indicated 104 in FIG. 5, of the dirt or potting soil 106 contained within the planter 100 to maintain a spacing of predetermined distance (e.g. about 1.5 inches) between the upper surface 104 and the discharge opening 34 provided in the head end 26 of the tube 24.

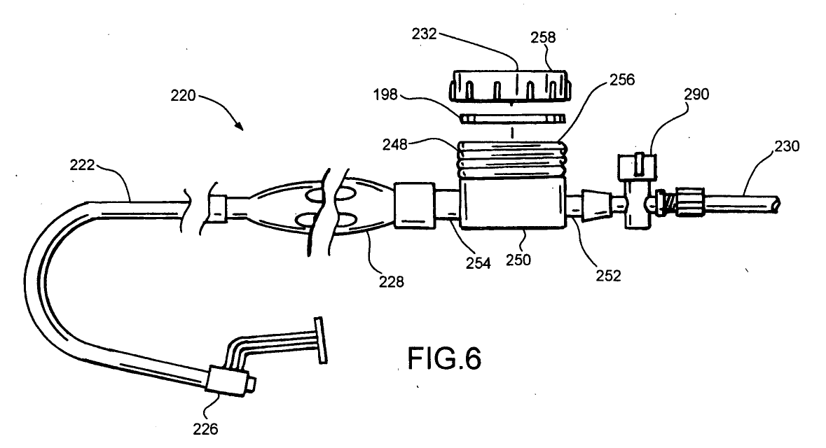

With reference to FIG. 6, there is illustrated an alternative embodiment, generally indicated 220, within which features of the present invention are embodied. The system 220 includes a watering wand 222 having an elongated hollow tube 224 having a head end 226 (provided with a U-shaped crook) and an opposite handle end 228. The system 220 also includes a conduit 230 for conducting water to the handle end 228 of the tube 224 and a nutrient-conducting assembly 232 which is connected in-line with the conduit 230.

A difference between the system 20 of FIGS. 1-5 and the system 220 of FIG. 6 is that the nutrient-containing assembly 232 of the FIG. 6 embodiment is connected directly to the handle end 228 of the wand 222 so that water and nutrients which exit the outlet port, indicated 254, of the nutrient-containing assembly 232 of the system 220 are conducted directly into the handle end 228 of the wand 222 for eventual discharge from the wand 222 through the head end 226 thereof.

Furthermore, a valve assembly 290 is mounted immediately upstream of the nutrient-containing assembly 232 so that water which is permitted to exit the valve assembly 290 flows directly in sequence through the inlet port, indicated 252, of the nutrient-holding assembly 232 and then into the wand 228. Such an arrangement can be advantageous in that the valve assembly 290 is easily accessible to a user at the wand 222 who may wish to shut OFF the water flow through the system 220 for the purpose of filling, or re-filling, the nutrient-containing assembly 232 with plant nutrients (e.g. granular fertilizer) and subsequently turn the water flow through the system 220 back ON.

Further still, the nutrient-containing assembly 232 of the FIG. 6 system 220 includes a receptacle portion 250 having the previously-introduced inlet and outlet ports 252 and 254, respectively, which are disposed in an aligned relationship with on another, and the receptacle portion 250 has a section, indicated 248 in FIG. 6, surrounding the mouth, indicated 256, which is substantially cylindrical in shape, rather than funnel-shaped. In addition, an elastomeric washer 198 is provided for placement across the mouth 256 of the receptacle portion 250 before the top, indicated 258, is threadably secured across the mouth 256 of the receptacle portion 250 to help seal the top 258 upon the receptacle portion 250.

Exemplary dimensions of the aforedescribed watering wand system 220 are provided here as follows: The length of the tube 224 as measured from the handle end 228 to the base of the U-shaped crook of the head end 226 is about 19.0 inches; the distance between the base of the U-shaped crook and the discharge end of the head end 226 is about 5.5 inches; the legs of the U of the U-shape of the tube 224 are about 5.5 inches apart; the tube 224 has an outer diameter (as measured along a major section of its length, such as for example, across the head end 226 of the tube 224) of about 0.375 inches; the largest diameter as measured across the handle end (i.e. the bulbuous portion) of the tube 224 is within the range of between about 1.0 inches and 1.5 inches, and is preferably about 1.125 inches; the diameter of the interior of the receptacle portion 250 of the nutrient-containing assembly is about 1.875 inches and its depth is about 1.0 inches; the inner diameter of the inlet port 252 of the receptacle portion 250 is about 0.16 inches, the inner diameter of the outlet port 254 of the receptacle portion 250 is about 0.25 inches; the outer diameter of the conduit 230 is about 0.25 inches; and the length of the conduit 230 is about 20 feet.

It will be understood that numerous modifications and substitutions can be had to the aforedescribed embodiments 20 or 220 without departing from the spirit of the invention. For example, although the aforedescribed embodiment 20 has been shown and described as including a wand 22 whose head end 26 is provided with a single discharge opening 34 (FIG. 2), the head end can be provided with an alternative number of discharge openings. For example, there is illustrated in FIG. 7 an alternative embodiment of a watering wand 122 having a head end 126 having a plurality of (e.g. three) discharge openings 128. Accordingly, the aforedescribed embodiments 20 and 220 are intended for the purpose of illustration and not as limitation.

1. A watering wand system for delivering water to an elevated planter having an upper edge, the system comprising:
a relatively stiff hollow tube having a head end and an opposite handle end and a water flow passageway extending between the head and handle ends of the tube, the tube including a crooked portion adjacent the head end of the tube which permits the head end of the tube to be hooked over the upper edge of an elevated planter for the purpose of delivering water from the head end of the tube into the planter; and
a nutrient-containing assembly having a hollow interior for holding plant nutrients placed therein and which is connected in-line with the water flow passageway of the hollow tube so that water which is routed to the hollow tube from a source enters the nutrient-containing assembly and is permitted to mix with nutrients placed therein before delivery to an elevated planter through the hollow tube.

2. The system as defined in claim 1 further including a a spacer member which is joined to the hollow tube adjacent the head end thereof for maintaining a spacing of predetermined distance between the head end of the tube and the upper surface of dirt or potting soil contained within the planter when the head end of the tube is hooked over the upper edge of the elevated planter for the purpose of delivering water from the head end of the tube into the planter.

3. The system as defined in claim 2 wherein the spacer member is sized to maintain a spacing of about 1.5 inches distance between the head end of the tube and the upper surface of dirt or potting soil contained within the planter when the head end of the tube is hooked over the upper edge of the elevated planter for the purpose of delivering water from the head end of the tube into the planter.

4. The system as defined in claim 1 wherein the handle end of the tube includes a portion which is bulbuous in shape to facilitate the grasping of the handle end of the tube by a user.

5. The system as defined in claim 4 wherein the largest diameter of the bulbuous portion is within the range of between about 1.0 inches and 1.5 inches.

6. The system as defined in claim 5 wherein the outer diameter of the hollow tube as measured across the head end of the tube is about 0.375 inches.

7. The system as defined in claim 1 wherein the hollow interior of the nutrient-containing assembly is cylindrical in shape and measures no greater than about 2.0 inches in diameter and about 1.0 inches in depth.

8. The system as defined in claim 1 wherein the outer diameter of the conduit is no larger than about 0.25 inches.

9. The system as defined in claim 1 wherein the nutrient-containing assembly has an inlet port into which water is conducted into the interior of the nutrient-holding assembly and an outlet port through which water and nutrients exit the interior of the nutrient-holding assembly, and the inner diameter of the outlet port is larger than the inner diameter of the inlet port.

10. The system as defined in claim 1 wherein the nutrient-containing assembly is connected to the hollow tube at the handle end thereof so that water and nutrients which are discharged from the hollow interior of the nutrient-containing assembly flow directly into the flow passageway of the hollow tube.

11. The system as defined in claim 1 further including a conduit for delivering water from a source to the nutrient-containing assembly and the hollow tube.

12. The system as defined in claim 1 further including a valve assembly associated with the hollow tube which permits a user to set the rate of water flowing through the flow passageway of the tube at a relatively slow flow rate.

13. A watering wand system for delivering water to an elevated planter having an upper edge, the system comprising:
a relatively stiff hollow tube having a head end and an opposite handle end and a water flow passageway between the head and handle ends of the tube, the tube including a crooked portion adjacent the head end of the tube which permits the head end of the tube to be hooked over the upper edge of an elevated planter for the purpose of delivering water from the head end of the tube into the planter;
a spacer member joined to the tube adjacent the head end thereof for maintaining a spacing of predetermined distance between the head end of the tube and the upper surface of dirt or potting soil contained within the planter when the head end of the tube is hooked over the upper edge of the elevated planter for the purpose of delivering water from the head end of the tube into the planter;
a conduit having an internal flow passageway and an inlet end to which water is delivered to the conduit from a source and having an outlet end which is connected in flow communication with the flow passageway of the tube by way of the handle end thereof so that water which is delivered to the conduit from a source is conducted into the flow passageway of the tube by way of the outlet end of the conduit;
a nutrient-containing assembly having a hollow interior and connected in-line with the conduit so that water which is directed into the conduit from the inlet end thereof is directed through the interior of the nutrient-containing assembly before entering the flow passageway of the tube through the handle end thereof; and
a valve assembly associated with the conduit permitting a user to set the rate of water flowing through the flow passageway of the tube at a relatively slow flow rate.

14. The system as defined in claim 13 wherein the handle end of the tube includes a portion which is bulbuous in shape to facilitate the grasping of the handle end of the tube by a user.

15. The wand system as defined in claim 13 the valve assembly is a first valve assembly, and the wand system further includes a second valve assembly associated with the conduit wherein the first valve assembly is mounted adjacent the outlet end of the conduit and the second valve assembly is mounted adjacent the inlet end of the conduit.

16. The system as defined in claim 13 wherein the tube includes a straight portion which extends from the handle end of the tube for a major segment of the length thereof.

17. The system as defined in claim 13 wherein the water flow passageways associated with each of the conduit, the nutrient-containing assembly and the tube are large enough in diameter to reduce the likelihood that the internal passageways thereof will become plugged by undissolved grains of granular fertilizer which are placed within the hollow interior of the nutrient-containing assembly.

18. The system as defined in claim 13 wherein the conduit has an inlet end which is adapted to be connected to the discharge connection of a faucet or garden hose for accepting water delivered therefrom.

19. The system as defined in claim 13 wherein the tube and the conduit includes internal passageways of relatively small diameter to reduce the weight of the tube and conduit when filled with water.

20. The system as defined in claim 13 wherein the nutrient-containing assembly includes a receptacle portion having a removable top within which plant nutrients can be placed for mixing with water conducted through the conduit before entering the tube through the handle end thereof.
